(19) United States
(12) Patent Application Publication
(10) Pub. No.: US 2019/0188275 A1
(43) Pub. Date: Jun. 20, 2019

(54) METHOD, DEVICE, STORAGE MEDIUM, TERMINAL FOR SERCHING AND RETRIEVING APPLICATIONS

(71) Applicant: Guangzhou UC Network Technology Co., Ltd., Guangzhou (CN)

(72) Inventor: Anteng Pan, Guangzhou (CN)

(73) Assignee: Guangzhou UC Network Technology Co., Ltd., Guangzhou (CN)

(21) Appl. No.: 16/131,673

(22) Filed: Sep. 14, 2018

(30) Foreign Application Priority Data
Dec. 20, 2017 (CN) 201711386542.7

(51) Int. Cl. G06F 17/30; G06N 99/00; G06N 5/02

(52) U.S. Cl. CPC G06F 17/3053; G06F 17/30867; G06N 5/022; G06N 99/005; G06F 17/30554

(57) ABSTRACT

The present disclosure teaches methods, devices, storage medium, and terminals for application retrieval. The method includes the following steps: obtaining a candidate application set according to a search term input by a first user; generating respective first features for characterizing relationships between the search term input by the first user and respective applications in the candidate application set; and inputting the respective first features into a prediction model to obtain estimated click-through rates of the respective applications in the candidate application set. The method further comprises ranking the respective applications in the candidate application set in descending order according to the estimated click-through rates, and displaying the respective applications in the candidate application set to the first user in a sequence ranked in descending order. The embodiments disclosed herein improves the effectiveness of application retrieval.

### PRIOTITY CLAIMS

The present application claims priority under the Paris Convention to Chinese Patent Application No. CN201711386542.7, titled Method, Device, Storage Medium, and Terminal for Retrieving Applications and filed on Dec. 20, 2017, the content of which is incorporated herein in its entirety.

### TECHNICAL

The present disclosure relates generally to the field of Internet technologies, and in particular, to methods and apparatus for retrieving applications.

### BACKGROUND

With the advancement of technology, numerous software applications are becoming available to users to download and use. An app store often provides a function of searching and retrieving applications for a user to find a desired application. In prior art, searching and retrieving an application generally uses a tf-idf (term frequency-inverse document frequency) algorithm. However, tf-idf method only works with content, for example, searches and retrieves the text information in a document, thus the result of a tf-idf method is difficult to guarantee when it is used to retrieve applications.

### SUMMARY

The present disclosure intends to address the shortcomings of the prior art, and provides an application retrieval method, device, storage medium, and terminal for the same, which are used to solve the problem of prior art application retrieval approaches and to improve the results of application retrieval.

According to a first aspect, an embodiment in the present disclosure provides an application retrieval method. The method includes the steps of: obtaining a candidate application set according to a search term input by a first user; generating respective first features for characterizing relationships between the search term input by the first user and respective applications in the candidate application set; inputting the respective first features into a prediction model to obtain estimated click-through rates of the respective applications in the candidate application set, wherein the prediction model is used to represent relationships between the features and estimated click-through rates of applications; ranking the respective applications in the candidate application set in descending order according to the estimated click-through rates, and displaying the respective applications in the candidate application set to the first user in a sequence ranked in descending order.

In one embodiment, before obtaining estimated click-through rates of the respective applications in the candidate application set, the method further comprises: acquiring historical search records of respective second users, wherein the historical search records include input search terms, respective applications obtained based on the search terms, and information about whether the respective applications are downloaded; generating respective second features for characterizing relationships between the search terms input by the respective second users and the respective applications; and inputting the respective second features into a preset model for training to generate a prediction model.

In one embodiment, the second features comprise a relevance feature, which is generated by the following steps: selecting one search term as the current search term from the search terms input by the respective second users, and selecting one application as the current application from respective applications obtained based on the current search term; segmenting the current search term, calculating a word frequency and an inverse document frequency of segments appearing in the current search term, and obtaining a feature vector of the current search term according to the word frequency and the inverse document frequency; segmenting text information of the current application, calculating a word frequency and an inverse document frequency of segments appearing in the text information, and obtaining a feature vector of the text information according to the word frequency and the inverse document frequency, wherein the text information includes title and/or description information; calculating a cosine value of an angle between the feature vector of the current search term and the feature vector of the text information as a corresponding relevance feature; and returning to select another search term as the current search term from the search terms input by the respective second users and select another application as the current application from respective applications obtained based on the current search term until all relevance features are generated.

In one embodiment, the historical search records further include the time when the respective applications are downloaded; and the second features further include a relevance-popularity crossing feature, which is generated by the following steps: ranking the respective applications obtained based on the current search term in descending order according to the relevance feature to obtain a relevance ranking of the current application in all applications (for example, all of the respective applications or all respective applications obtained based on the current search term); counting, according to the historical search records, the download times of the respective applications obtained based on the current search term in a preset time period, ranking the respective applications obtained based on the current search term in descending order according to the download times, and obtaining a popularity ranking of the current application in all applications; crossing the relevance ranking and the popularity ranking to obtain a corresponding relevance-popularity crossing feature; and returning to select another search term as the current search term from the search terms input by the respective second users and select another application as the current application from respective applications obtained based on the current search term until all relevance-popularity crossing features are generated.

In one embodiment, the second features further comprise a historical earning feature, which is generated by the following steps: selecting one search term as the current search term from the search terms input by the respective second users, and selecting one application as the current application from respective applications obtained based on the current search term; counting, according to the historical search record, the number of users among all second users who input the current search term who have downloaded the current application, and the number of times the current application is displayed in search lists of all second users who input the current search term; calculating a ratio of the number of users to the number of times as a corresponding historical earning feature; and returning to select another search term as the current search term from the search terms input by the respective second users and select another application as the current application from respective applications obtained based on the current search term until all historical earning features are generated.

In one embodiment, the second features further comprise an exact matching feature, which is generated by the following steps: selecting one search term as the current search term from the search terms input by the respective second users, and selecting one application as the current application from respective applications obtained based on the current search term; detecting whether a title of the current application matches the current search term; if yes, taking a first value as a corresponding exact matching feature; otherwise, taking a second value as a corresponding exact matching feature; and returning to select another search term as the current search term from the search terms input by the respective second users and select another application as the current application from respective applications obtained based on the current search term until all exact matching features are generated.

In one embodiment, the second features further comprise a segment-to-application feature, which is generated by the following steps: selecting one search term as the current search term from the search terms input by the respective second users, and selecting one application as the current application from respective applications obtained based on the current search term; segmenting the current search term; combining a segment of the current search term with the title of the current application as a corresponding segment-to-application feature; and returning to select another search term as the current search term from the search terms input by the respective second users and select another application as the current application from respective applications obtained based on the current search term until all segment-to-application features are generated.

In one embodiment, the first features are one-hot encoded.

According to a second aspect, an embodiment of the present disclosure also provides an application retrieval device, comprising: a candidate application set obtaining circuit configured to obtain a candidate application set according to a search term input by a first user; a first feature generating circuit configured to generate respective first features for characterizing relationships between the search term input by the first user and respective applications in the candidate application set; an estimated click-through rate obtaining circuit configured to input the respective first features into a prediction model to obtain estimated click-through rates of the respective applications in the candidate application set, wherein the prediction model is used to represent association relationships between features and estimated click-through rates of applications; and an application displaying circuit configured to rank the respective applications in the candidate application set in descending order according to the estimated click-through rates, and display the respective applications in the candidate application set to the first user in a sequence in accordance to the ranked order.

According to a third aspect, an embodiment of the present disclosure also provides a computer readable storage medium having stored thereon a computer program, wherein the program is executed by a processor to implement the application retrieval method according to any one of the above.

According to a fourth aspect, an embodiment of the present disclosure also provides a terminal, comprising: one or more processors; and a storage device configured to store one or more programs, wherein the one or more programs are executed by the one or more processors to implement the application retrieval method of any one of the above.

The above application retrieval method and device, storage medium and terminal firstly retrieves respective applications according to a search term input by a user, in order to satisfy the degree that the retrieved content matches what is searched for, and then obtain estimated click-through rates of the respective applications by inputting respective generated first features into a prediction model, and determine the display order of the respective retrieved applications according to the estimated click-through rates. The user can quickly find a popular application having a high estimated click-through rate based on the display order, improving the efficiency for a user to find a desired application. The methods disclosed herein rely on click-through rates and other indicators as compared to the traditional tf-idf algorithm and are therefore much improved.

Furthermore, an application retrieval method combining content, application popularity (relevance-popularity crossing feature) and user feedback (historical earning feature) is proposed. The proposed method not only satisfies the matching degree that the retrieved content should match what is searched for, but also greatly improves over traditional methods and better meets user requirements.

The additional aspects and advantages of the present disclosure will be set forth in part in the description which follows and become clear from the following description or learnt by practicing the present disclosure.

### BRIEF DESCRIPTION OF THE DRAWINGS

The above and additional aspects and advantages of the present disclosure will become apparent and readily understood from the description of the embodiments in combination with the drawings hereinafter.

FIG. 1 is a schematic flow chart of an application retrieval method according to an embodiment of the present disclosure;

FIG. 2 is a schematic structural diagram of an application retrieval device according to an embodiment of the present disclosure; and

FIG. 3 is a schematic structural diagram of a terminal according to an embodiment of the present disclosure.

### DETAILED DESCRIPTION

The embodiments of the present disclosure are described in detail below, and the examples of the embodiments are illustrated in the drawings, in which the same or similar reference numerals are used to refer to the same or similar elements or elements having the same or similar functions. The embodiments described below with reference to the drawings are intended to be illustrative of the present disclosure and are not to be construed as limiting.

It should be understood by those skilled in the art that the singular forms “a”, “an”, “the” may include plural forms unless explicitly stated. It should be understood that the words “first”, “second” and the like used in the present disclosure are only used to distinguish the same technical features, rather than limiting the order and the number of the technical features. It should be further understood that the phrase “comprise” refers to the existence of the features, integers, steps, operations, elements, components, and/or groups thereof but does not exclude the existence or addition of one or more other features, integers, steps, operations, elements, components, and/or groups. It will be understood that when an element is referred to as being “connected” or “coupled” to another element, it may be directly connected or coupled to the other element or there may be an intervening element. Further, “connected” or “coupled” as used herein may include either a wireless connection or a wireless coupling. The term “and/or” used herein includes all or any of one or more associated listings.

Those skilled in the art will appreciate that all terms (including technical and scientific terms) used herein have the same meaning as commonly understood by one of ordinary skill in the art to which the present disclosure belongs, unless otherwise defined. It should also be understood that terms such as those defined in a general dictionary should be understood to have meaning consistent with the meaning in the context of the prior art, and will not be construed with an idealized or excessively formal meaning unless specifically defined as here.

Those skilled in the art may understand that the “terminal” and “terminal device” as used herein include both a wireless signal receiver device without a transmitting capability and receiving and transmitting hardware capable of performing two-way communication over a two-way communication link. Such a device may include a cellular or other communication device having a single line display or a multi-line display or a cellular or other communication device without a multi-line display; PCS (Personal Communications Service), which may combine voice, data processing, facsimile, and/or data communication capabilities; PDA (Personal Digital Assistant), which may include radio frequency receivers, pagers, Internet/Intranet access, web browsers, notepads, calendars, and/or GPS (Global Positioning System) receiver; conventional laptop and/or palmtop computer or other device having and/or including a radio frequency receiver. As used herein, “terminal” and “terminal device” may be portable, transportable, installed in a vehicle (aviation, sea and/or land), or adapted and/or configured to operate locally, and/or run in any other location on the earth and/or space in a distributed form. The “terminal” and “terminal device” used herein may also be a communication terminal, an internet terminal, a music/video playing terminal, and may be, for example, a PDA, a MID (Mobile Internet Device), and/or a mobile phone having a music/video playing function, and may also be smart TVs, set-top boxes and other devices.

It is necessary to first make the following preliminary description of the application scenarios and principles of the present disclosure.

The application retrieval method, device, storage medium and terminal described in the present disclosure may be deployed in a terminal, such as a mobile phone or a computer. The terminal for inputting a search term by a user terminal and the terminal for retrieving an application may be the same terminal or different terminals. For example, the user may input a search term in the mobile phone, and then the mobile phone sends the search term to a server to perform application retrieval. The server sends back the final retrieval result to the mobile phone. Alternatively, the user may input a search term in the mobile phone, and the mobile phone directly retrieves an application according to the search term, and displays the retrieval result on the mobile phone screen.

The present disclosure is divided into two parts. The first part is about an application retrieval process. A retrieval process preliminarily defines a batch of applications as a candidate application set according to a search term s input by a user u. The second part is about a refinement process, which carries out a second ranking process on the retrieved applications to produce the final result.

The specific embodiments of the present disclosure are described in detail below with reference to the accompanying drawings.

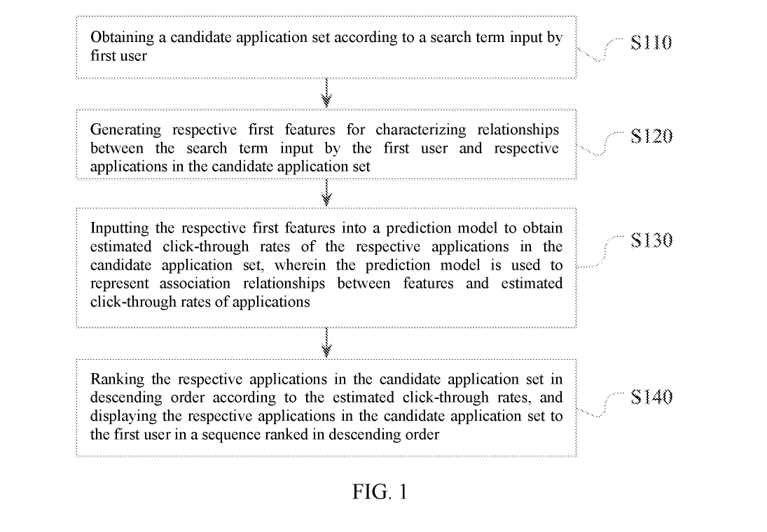

In one embodiment, as shown in FIG. 1, an application retrieval method includes the following steps.

In step S110, a candidate application set is obtained according to a search term input by a first user.

This step is a step in the application retrieving process. The first user is a user who currently needs or wants to retrieve an application. The search term is a term that the user inputs in order to retrieve an application, for example, “Xiao Xiao Le”. The number of search terms may be one or more. The length of the search term can be a short word or a long sentence. There are many ways for the first user to input a search term. For example, the first user may input the search term directly in a search window by using a touch pen or finger, or input the search term in the search window through a keyboard or a mouse, etc. The input method shall not be limited by the present disclosure. The candidate application set is a collection of several applications that have been retrieved in response to the search term input by the first user.

There are many ways to obtain a candidate application set according to the input search term. In the following sections, a tf-idf algorithm is described as an example to illustrate the retrieval process. It should be understood that the present disclosure is not limited to using tf-idf algorithms to retrieve applications.

In some embodiments, obtaining a candidate application set according to a search term input by a first user includes the following steps.

In step S1101 (not shown in FIG. 1), a tf-idf vector of a search term s and a tf-idf vector of text information of an application i are generated, wherein the text information includes a title and/or description information and the like.

The following describes an example of generating a tf-idf vector of the description information of the application i.

In step S1101a, a word frequency feature of the description information of the mobile phone application i is extracted.

Extracting the word frequency feature of the application i includes the following steps. In step 1, the content of the application i is segmented. Optionally, the segmentation result may be filtered during the segmentation to retain the segments reflecting the text content. In step 2, the probability of occurrence of each segment is counted. In step 3, the probability of occurrence of each segment is taken as the weight of the segment. The word frequency feature vector of the application i may be obtained and recorded as tfᵢ shown below:

tfᵢ={w1:tf1,w2:tf2,w3:tf3, . . . }

For example, the segmentation result of the phrase “input method with the most accurate typing and the most personalized interface” is

tfᵢ={typing: 0.2, accurate: 0.2, interface: 0.2, personalized: 0.2, input method: 0.2}

In step S1101b, an inverse document frequency of different segments is calculated.

I represents a collection of all mobile phone applications in a repository.

isContain_{i,j} indicates whether a segment j appears in the application i. The value of “1” indicates that it appears, and “0” indicates that it does not appear.

idfⱼ represents an inverse document frequency of the segment j, and the calculation formula is as follows:

$${idf}_{j} = \frac{1}{{log}_{2} ( 1 + {\sum }_{i ∈ I} {isContain}_{i , j} )}$$

In step S1101c, the tf-idf vector of the description information of the application i is constructed.

tfidf_{i,j} represents a tf-idf value of the segment j in the application i, and the calculation formula is as follows:

tfidf_{i,j}=idfⱼ·tf_{i,j}

Through the above formula, the tf-idf vector of application i may be obtained, denoted as tdf

tdfᵢ=(tfidf_{i,1},tfidf_{i,2}, . . . )

A similar method may be used to obtain the tf-idf vector tdfs of the search term and the tf-idf vector tdftᵢ of the application title tᵢ. If the text information of the application also includes other content, a similar method may be used to obtain the corresponding tf-idf vector.

In step S1102 (not shown in FIG. 1), the tf-idf similarity between the application i and the search term s is calculated.

The similarity is solved by a cosine relevance coefficient, specifically:

simTitle_{s,i} represents the tf-idf similarity between the search term s and the title of the application i,

simInfo_{s,i} represents the tf-idf similarity between the search term s and the description information of the application i,

simTitle_{s,i}=cos<tdfs,tdftᵢ>

simInfo_{s,i}=cos<tdfs,tdfᵢ>

In step S1103 (not shown in FIG. 1), applications are selected.

Applications are selected based on the similarity obtained in step S1102 (not shown in FIG. 1). There are many ways to select an application. In one embodiment, an application whose similarity is greater than a certain threshold may be retrieved. In another embodiment, the respective applications may be ranked in descending order of the similarities. Then a pre-determined number of applications is selected as the retrieved applications starting from the application with the highest similarity. The number of applications to be selected may be determined according to a specific case or actual requirements.

For example, for the search term s, the simTitle_{s,i} is used to rank the whole library in descending order (in practice, the application segmentation information is stored in the system through an inversion method), and the first 300 applications are selected. Similarly, the simInfo_{s,i} coefficient may also be used to select 300 applications. Optionally, the combination of applications retrieved by the two methods may be used as a candidate application set. Alternatively, the applications retrieved by the two methods may be further filtered by a preset rule, and a collection of respective applications retained after filtering may be used as a candidate application set.

In step S120 shown in FIG. 1, respective first features for characterizing relationships between the search term input by the first user and the respective applications in the candidate application set are generated.

Steps S120 to S140 shown in FIG. 1 are steps of refinement. The first features described in these steps are the same concept as the second features and the features that are subsequently mentioned. In one embodiment, the first features and/or the second features that are subsequently mentioned may use one-hot encoding. One-hot encoding method discretizes each dimension into two values, 0 and 1. For example, age dimension values “child”, “juvenile”, “youth”, “old age” can be one-hot encoded to be divided into 4 features. It is noted that in this embodiment, features are classified or divided using one-hot encoding method. However, they can be encoded in other forms as well.

Optionally, features may comprise: any one of or any combination of an exact matching feature, a historical earning feature, a relevance feature (including a title relevance feature and/or a description relevance feature), a segment-to-application feature, and a relevance-popularity crossing feature. Let's assume that the search term input by the first user is s and an application in the candidate application set is i. The respective first features for characterizing the relationship between the search term s and the application i are described below.

Feature 1: exact matching feature

The value of this feature (“0” or “1”) indicates whether the title of the application i is completely consistent with the search term s. If yes, the feature is_match=first value (for example, “1”) is returned. Otherwise the feature is_match=second value (for example, “0”) is returned.

Feature 2: historical earning feature

Feature ctr_{s,i} of the search term and the application describes the conversion rate of the search term s to the application i, indicating the portion or percentage of the users downloading the application i in the search list of the search term s:

$${ctr}_{s , i} = \frac{\begin{matrix}the number of users who download application i in all \\ users searching for s\end{matrix}}{\begin{matrix}the number of times application i is displayed in the \\ search lists of all users searching for i\end{matrix}}$$

Optionally, the historical earning feature ctr_{s,i} may be a decimal number, for example, having 3 digits after the decimal point. For example, ctr_{s,i}=0.123. In the event where there is no user feedback information of the search term s to the application i in the historical search records, the default value, feature ctr_{s,i}=null, is returned. Since the historical earning feature requires other user feedback information and the above described steps have only acquired or obtained information of the search term input by the first user and the candidate application set at this point in the process, the value of the historical earning feature for the first features is ctr_{s,i}=null.

Feature 3: title relevance feature

The title relevance feature refers to a relevance feature of the search term s and the title of the application i. The calculation method thereof is consistent with the retrieval process (step S110).

simTitle_{s,i}=cos<tdfs,tdftᵢ>

Optionally, the title relevance feature may be expressed as a decimal number with 3 digits after the decimal point. For example, simTitle_{s,i}=0.789.

Feature 4: description relevance feature

The description relevance feature refers to a relevance feature of the search term s and the description information of the application i. The calculation method thereof is consistent with the recall process (step S110).

simInfo_{s,i}=cos<tdfs,tdfᵢ>

Optionally, the description relevance feature is a decimal number with 3 digits after the decimal point. For example, simInfo_{s,i}=0.123.

Feature 5: segment-to-application feature

The segment-to-application feature relates to segmenting of the search term s. Each segment-to-application i is a feature. The process generates multiple features. For example, the search term is “Xiao Xiao Game” and the application is “Kai Xin Xiao Xiao Le”. The search term can be segmented as “Xiao Xiao” and “Game”, and two segment-to-application features can be generated as a result. The first one is “Xiao Xiao & Kai Xin Xiao Xiao Le” and the second one is “Game & Kai Xin Xiao Xiao Le”.

Feature 6: relevance-popularity crossing feature

The relevance-popularity crossing feature indicates the popularity of the application i with respect to the relevance of the search term s to the application i. This feature is determined in a method described as follows.

First, relevance ranking of the application i and the search term s in all applications retrieved based on the search term s by ordering all retrieved applications in descending order according to simTitle_{s,i}+simInfo_{s,i} (if only one feature is generated, there is no need to do a summation) to obtain the relevance ranking of the application i and the search term s denoted as relateRn_{s,i}.

Second, a popularity ranking of the application i in all applications retrieved based on the search term s by ranking all retrieved applications in descending order of downloads (e.g., average downloads) within a preset time (e.g., the recent week) in the application store to obtain the popularity ranking of the application i denoted as hotRn_{s,i}.

Finally, the above two features are crossed (e.g., using feature vector crossing operation in one-hot encoding) to obtain a relevance-popularity crossing feature.

For example, relateRn_{s,i}=23&hotRn_{s,i}=31.

Since the download amount of the application is null in this step S120, the relevance-popularity crossing is null.

In step S130, the respective first features are input into a prediction model to obtain estimated click-through rates of the respective applications in the candidate application set. A prediction model represents association relationships between features and estimated click-through rates of applications.

A prediction model is used to receive features as input and output estimated click-through rates of an application. Prediction models may be trained offline in advance. After the respective first features are obtained through the above steps, a click-through rate is estimated for each retrieved application by invoking the trained prediction model to obtain the estimated click-through rates of the respective applications in the candidate application set. The estimated click-through rate is the first user's estimated click-through rate (i.e., download rate) for an application, that is, the probability that the first user will download the application.

The prediction model can be improved or trained through machine learning. In one embodiment, before obtaining estimated click-through rates of the respective applications in the candidate application set, the method may further include the following steps.

In step S080 (not shown in FIG. 1), historical search records of respective second users are acquired, wherein the historical search records include an input search term, respective applications obtained based on the search term, and information about whether the respective applications are downloaded.

The respective second users are users who have previously searched for an application. The historical search records are records generated when the respective second users searched for applications, including: a search term, which is a word input by a user when searching for an application; applications, which are applications retrieved according to the search term input by the user; information about whether there is any download, which is information about whether the user clicks to download an application when the application is among the retrieved applications in response to a user inputting the search term. In order to describe the information whether the application is downloaded, different values may be used. For example, 1 means the application is downloaded, and 0 means the application is only displayed (exposed) but not downloaded. In addition, shown in Table 1 is the collected historical search exposure click-through data (i.e., historical search record). Optionally, a historical search record may further include: a user ID, such as an account registered by the user when performing retrieval in the application store or a device ID of the user, etc.; and/or, the time when the respective applications are downloaded.

TABLE 1
historical search record

| | | | downloaded or | |
|---|---|---|---|---|
| user ID | search term | application | not | download time |
| U1 | S1 | A1 | 0 | |
| U2 | S2 | A1 | 1 | T1 |
| . . . | . . . | . . . | . . . | . . . |

In step S090 (not shown in FIG. 1), second features for characterizing relationships between the search terms input by the respective second users and the respective applications are generated.

Optionally, the second feature comprises: any one or any combination of: an exact matching feature, a historical earning feature, a relevance feature (including a title relevance feature and/or as description relevance feature), a segment-to-application feature, and a relevance-popularity crossing feature. The manner of generating the respective second features according to the historical search record is similar to the manner of generating the respective first features. Let's assume that the current search term is s, and the current application is i. The following describes the respective second features for characterizing relationships between the current search term s and the current application i.

Feature 1: exact matching feature

In one embodiment, the exact matching feature is generated by the following steps: selecting one search term as the current search term from the search terms input by the respective second users, and selecting one application as the current application from respective applications obtained based on the current search term; detecting whether a title of the current application is completely consistent with the current search term; if yes, assigning a first value to the corresponding exact matching feature; otherwise, assigning a second set value to the corresponding exact matching feature; and returning to select another search term as the current search term from the search terms input by the respective second users and select another application as the current application from respective applications obtained based on the current search term until all exact matching features are generated.

Then whether a title of the current application i is completely consistent with the current search term s is determined. If yes, the feature is_match is assigned a first value (for example, 1) and is returned. Otherwise the feature is_match=second value (for example, 0) is returned.

Feature 2: historical earning feature

In one embodiment, the historical earning feature is generated by the following steps: selecting one search term as the current search term from the search terms input by the respective second users, and selecting one application as the current application from respective applications obtained based on the current search term; counting, according to the historical search records, the number of users who have downloaded the current application among all second users who input the current search term, and the number of times the current application is displayed in the search lists of all second users who input the current search term; calculating a ratio of the number of users to the number of times as a corresponding historical earning feature; and returning to select another search term as the current search term from the search terms input by the respective second users and select another application as the current application from respective applications obtained based on the current search term until all historical earning features are generated.

A feature ctr_{s,i} of the search term and the application is generated according to the behavior feedback data of the respective second users. The feature ctr_{s,i} of the search term and the application is the conversion rate of the search term s to the application i, indicating the proportion of the user downloading the application in a search list of the search term s

$${ctr}_{s , i} = \frac{\begin{matrix}the number of users who download application i in all \\ users searching for s\end{matrix}}{\begin{matrix}the number of times application i is displayed in the \\ search lists of all users searching for i\end{matrix}}$$

Optionally, the historical earning feature is a decimal number with 3 digits after the decimal point. For example, ctr_{s,i}=0.123. In the case where there is no user feedback information of the search term s to the application i in the historical search records, the default feature ctr_{s,i}=null is returned.

Feature 3: title relevance feature

In one embodiment, a relevance feature is usually generated by the following steps: selecting one search term as the current search term from the search terms input by the respective second users, and selecting one application as the current application from respective applications obtained based on the current search term; segmenting the current search term into smaller phrases or single words that are referred to as “segments”, calculating a word frequency and an inverse document frequency of segments appearing in the current search term, and obtaining a feature vector of the current search term according to the word frequency and the inverse document frequency; segmenting the text information of the current application, calculating a word frequency and an inverse document frequency of segments appearing in the text information, and obtaining a feature vector of the text information according to the word frequency and the inverse document frequency, wherein the text information includes title and/or description information; taking a cosine value of an angle between the feature vector of the current search term and the feature vector of the text information as a corresponding relevance feature; and returning to select another search term as the current search term from the search terms input by the respective second users and select another application as the current application from respective applications obtained based on the current search term until all relevance features are generated.

The title relevance feature can be obtained by merely replacing the text information in the above steps with the title of an application.

The title relevance feature refers to a relevance feature of the search term s and the title of the application i. The calculation method thereof is consistent with the retrieval process described in step S110:

simTitle_{s,i}=cos<tdfs,tdftᵢ>

Optionally, the title relevance feature is a decimal number with 3 digits after the decimal point. For example, simTitle_{s,i}=0.789.

Feature 4: description relevance feature

In one embodiment, a relevance feature is generated by the following steps: selecting one search term as the current search term from the search terms input by the respective second users, and selecting one application as the current application from respective applications obtained based on the current search term; segmenting the current search term into segments, calculating a word frequency and an inverse document frequency of segments appearing in the current search term, and obtaining a feature vector of the current search term according to the word frequency and the inverse document frequency; segmenting text information of the current application into text information segments, calculating a word frequency and an inverse document frequency of the text information segments, and obtaining a feature vector of the text information according to the word frequency and the inverse document frequency, wherein the text information includes title and/or description information; calculating a cosine value of an angle between the feature vector of the current search term and the feature vector of the text information as a corresponding relevance feature; and returning to select another search term as the current search term from the search terms input by the respective second users and select another application as the current application from respective applications obtained based on the current search term until all relevance features are generated.

The description relevance feature may be obtained by merely replacing the text information in the above steps with the description information.

The description relevance feature refers to a relevance feature of the search term s and the description information of the application i. The calculation method thereof is consistent with the retrieval process described in step S110.

simInfo_{s,i}=cos<tdfs,tdfᵢ>

Optionally, the description relevance feature may be a decimal number with 3 digits. For example, simInfo_{s,i}=0.123.

Feature 5: segment-to-application feature

In one embodiment, the segment-to-application feature is generated by the following steps: selecting one search term as the current search term from the search terms input by the respective second users, and selecting one application as the current application from respective applications obtained based on the current search term; segmenting the current search term into segments; combining a segment of the current search term with the title of the current application as a corresponding segment-to-application feature; and returning to select another search term as the current search term from the search terms input by the respective second users and select one application as the current application from respective applications obtained based on the current search term until all segment-to-application features are generated.

The segment-to-application feature depends on how the search term s is segmented. Each segment-to-application i is a feature. The process generates multiple features. For example, the search term is “Xiao Xiao Game” and the application is “Kai Xin Xiao Xiao Le”. The search term is segmented into “Xiao Xiao” and “Game”, and two segment-to-application features are generated. The first one is “Xiao Xiao & Kai Xin Xiao Xiao Le” and the second one is “Game & Kai Xin Xiao Xiao Le”.

Feature 6: relevance-popularity crossing feature

In one embodiment, the relevance-popularity crossing feature is generated by the following steps: ranking the respective applications obtained based on the current search term in descending order according to the relevance feature, to obtain a relevance ranking of the current application in all applications; counting, according to the historical search records, the download amount (e.g., the number of times an application has been downloaded) of the respective applications in a preset time period is obtained based on the current search term, ranking the respective applications obtained based on the current search term in descending order according to the download amount, and obtaining a popularity ranking of the current application in all applications; crossing the relevance ranking and the popularity ranking to obtain a corresponding feature of relevance and popularity crossing; and returning to select another search term as the current search term from the search terms input by the respective second users and select another application as the current application from respective applications obtained based on the current search term until all relevance-popularity crossing features are generated.

The relevance-popularity crossing feature refers to considering the popularity of the application i while considering the relevance of the search term s to the application i. The method is described as below.

A relevance ranking of the application i and the search term s in all applications retrieved based on the search term s by ordering all retrieved applications in descending order according to simTitle_{s,i}+simInfo_{s,i} (if only one feature is generated, there is no need to sum) to obtain the relevance ranking of the application i and the search term s denoted as relateRn_{s,i}.

A popularity ranking of the application i in all applications retrieved based on the search term s is obtained by ranking all retrieved applications in descending order of downloads (e.g., average downloads) within a preset time (e.g., the recent week) in the application store. The popularity ranking of the application i is denoted as hotRn_{s,i}.

The above two features are crossed to obtain a relevance-popularity crossing feature.

For example, relateRn_{s,i}=23&hotRn_{s,i}=31.

In step S100, the respective second features are input into a pre-selected or pre-determined model for training to generate the prediction model.

After the respective second features are generated, model feature data, that is, training samples, are obtained, as shown in Table 2. Optionally, the preset model is an LR (Logical Regression) model. The data (training sample data) in table 2 is trained using the industry's commonly used LR model training algorithm to obtain model parameters, that is, the preset model.

TABLE 2
training sample data

| user | search | | | downloaded | download |
|---|---|---|---|---|---|
| ID | term | application | feature | or not | time |
| U1 | S1 | A1 | F1, F2, F3 . . . | 0 | |
| U2 | S2 | A1 | F4, F5, F6 . . . | 1 | T1 |
| . . . | . . . | . . . | | . . . | . . . |

In step S140, the applications in the candidate application set are ranked in descending order according to the estimated click-through rates, and the applications in the candidate application set are displayed to the first user in a sequence ranked in descending order.

The offline trained model estimates a click-through rate for each application in the retrieved application candidate set, ranks the applications in descending order according to the estimated click-through rates, and returns the same to the user client to display to the user in sequence, so that the user may quickly select a desired application.

Based on the same inventive concept, the present disclosure further provides an application retrieval device. A specific implementation of the device of the present disclosure will be described in detail below with reference to the accompanying drawings.

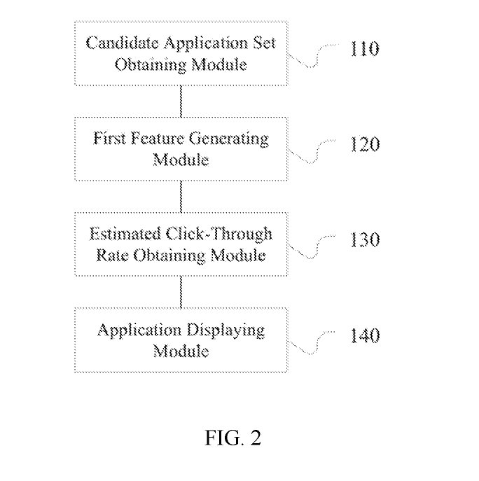

As shown in FIG. 2, in one embodiment, an application retrieval device includes the modules described below. It is noted that the term “module” herein refers to either hardware component or software programs. For example, a module may be one or more processors or circuits. The hardware component may be hard-coded to perform or carry out the various functions described herein. A module may be software programs that are stored in a memory or data storage and can be executed to perform or carry out the various functions described herein.

The application retrieval device may include a candidate application set obtaining module 110 configured to obtain a candidate application set according to a search term input by a first user.

The first user is a user who currently wants to retrieve an application. The search term is a term that the user inputs in order to retrieve an application, for example, “Kai Xin Xiao Xiao Le”. The number of search terms may be one or more. The length of the search term may also be a short word or a long sentence. There are many ways for the first user to input a search term. For example, the first user may input the search term directly in a search window by using a touch pen or finger, or input the search term in the search window through a keyboard or a mouse, etc., or any other input methods that are not mentioned herein in the present disclosure. The candidate application set is a collection of several applications that match the content of what is retrieved by the search term input by the first user.

There are many ways to obtain a candidate application set according to an input search term, one of which is described in the following by using a tf-idf algorithm as an example to illustrate the application retrieval process. It should be understood that the present disclosure is not limited to retrieving applications using tf-idf algorithms.

A first feature generating module 120 is configured to generate respective first features for characterizing relationships between the search term input by the first user and respective applications in the candidate application set.

In one embodiment, the first features and/or the second features that subsequently appear may be one-hot encoded. One-hot encoding discretizes each dimension into a form of 0 and 1. For example, age dimension values “child”, “juvenile”, “youth”, “old age,” which are one-hot encoded, can be decomposed into 4 features. It should be understood that the features are not limited to one-hot encoding, and may be encoded in other forms.

Optionally, the features comprise: any one or any combination of an exact matching feature, a historical earning feature, a relevance feature (including a title relevance feature and/or a description relevance feature), a segment-to-application feature, and a relevance-popularity crossing feature. The method of generating the respective second features according to the historical search records is similar to that of generating the respective first features. Assume that the current search term is s, and the current application is i. The following describes the respective second features for characterizing relationships between the current search term s and the current application i.

Feature 1: exact matching feature

It is detected whether a title of the current application i is completely consistent with the current search term s. If yes, the feature is_match=first set value (for example, 1) is returned, otherwise the feature is_match=second set value (for example, 0) is returned.

Feature 2: historical earning feature

A feature ctr_{s,i} of the search term and the application is the conversion rate of the search term s to the application i, indicating the proportion of the users downloading the application in a search list of the search term s:

$${ctr}_{s , i} = \frac{\begin{matrix}the number of users who download application i in all \\ users searching for s\end{matrix}}{\begin{matrix}the number of times application i is displayed in the \\ search lists of all users searching for i\end{matrix}}$$

Optionally, the historical earning feature may be a decimal number with 3 digits after the decimal point. For example, ctr_{s,i}=0.123. In the case where there is no user feedback information of the search term s to the application i in the historical search records, the default feature ctr_{s,i}=null is returned.

Feature 3: title relevance feature

The title relevance feature refers to a relevance feature of the search term s and the title of the application i:

simTitle_{s,i}=cos<tdfs, tdftᵢ>

Optionally, the title relevance feature is a decimal number with 3 digits after the decimal point. For example, simTitle_{s,i}=0.789.

Feature 4: description relevance feature

The description relevance feature refers to a relevance feature of the search term s and the description information of the application i.

simInfo_{s,i}=cos<tdfs, tdfᵢ>

Optionally, the description relevance feature is a decimal number with 3 digits after the decimal point. For example, simInfo_{s,i}=0.123.

Feature 5: segment-to-application feature

The segment-to-application feature refers to segmenting the search term s. Each segment to application i is a feature. The process generates multiple features. For example, the search term is “Xiao Xiao Game” and the application is “Kai Xin Xiao Xiao Le”. The search term is segmented into “Xiao Xiao” and “Game”, and two segment-to-application features are generated. The first one is “Xiao Xiao & Kai Xin Xiao Xiao Le” and the second one is “Game & Kai Xin Xiao Xiao Le”.

Feature 6: relevance-popularity crossing feature

The relevance-popularity crossing feature describes the popularity of the application i in the context of the relevance of the search term s to the application i. The method is described as below.

A relevance ranking of the application i and the search term s in all retrieved applications based on the search term s by ordering all retrieved applications in descending order according to simTitle_{s,i}+simInfo_{s,i} (if only one feature is generated, there is no need to sum) to obtain the relevance ranking of the application i and the search term s denoted as relateRn_{s,i}.

A popularity ranking of the application i in all retrieved applications based on the search term s is obtained by ranking all retrieved applications in descending order of downloads (e.g., average downloads) within a preset time (e.g., the recent week) in the application store to obtain the popularity ranking of the application i denoted as hotRn_{s,i}.

The above two features are crossed to obtain a relevance-popularity crossing feature.

For example, relateRn_{s,i}=23&hotRn_{s,i}=31.

Since the download amount of the application is null in this step S120, the relevance-popularity crossing is null.

An estimated click-through rate obtaining module 130 is configured to input the respective first features into a prediction model to obtain estimated click-through rates of the respective applications in the candidate application set, wherein the prediction model is used to represent association relationships between features and estimated click-through rates of applications.

The prediction model is used to input features and output estimated click-through rates of applications. The prediction model may be trained offline in advance. After the respective first features are obtained through the above steps, a click-through rate is estimated for each retrieved application by calling the trained prediction model to obtain the estimated click-through rates of the respective applications in the candidate application set. The estimated click-through rate is the first user's estimated click-through rate (e.g., download rate) for an application, that is, the probability that the first user is interested in the application.

In one embodiment, a prediction model generating module connected to the estimated click-through rate module is further included. The prediction model generating module is configured to perform the following operations:

In operation A, historical search records of respective second users are acquired, wherein a historical search record includes an input search term, respective applications obtained based on the search term, and information about whether the respective applications are downloaded.

The respective second users are users who have previously retrieved an application. The historical search records are records generated when the respective second users perform application retrieval. A historical search record includes a search term, which is a word input by the user when performing retrieval; applications, which are applications retrieved according to the search term input by the user; information about whether there is any download, i.e., information about whether the user clicks to download an application when the application is retrieved according to the input search term. In order to describe the information whether the application is downloaded, different values may be set to indicate different situations. For example, 1 means the application is downloaded, and 0 means the application is only displayed (exposed) but not downloaded. In addition, shown in Table 1 is the collected historical search exposure click-through data (i.e., historical search record). Optionally, a historical search record may further include: a user ID, such as an account registered by the user when performing retrieval in the application store or a device ID of the user, etc.; and/or, the time when the respective applications are downloaded.

In operation B, respective second features for characterizing relationships between the search terms input by the respective second users and the respective applications are generated.

Optionally, the second feature comprises: any one or any combination of an exact matching feature, a historical earning feature, a relevance feature (including a title relevance feature and/or as description relevance feature), a segment-to-application feature, and a relevance-popularity crossing feature. Let's assume that the current search term is s, and the current application is i. The following describes the respective second features for characterizing relationships between the current search term s and the current application i.

Feature 1: Exact matching Features

In one embodiment, the exact matching feature is generated by the following steps: selecting one search term as the current search term from the search terms input by the respective second users, and selecting one application as the current application from respective applications obtained based on the current search term; detecting whether a title of the current application is completely consistent with the current search term; if yes, taking a first set value as a corresponding exact matching feature; otherwise, taking a second set value as a corresponding exact matching feature; and returning to select another search term as the current search term from the search terms input by the respective second users and another application as the current application from respective applications obtained based on the current search term until all exact matching features are generated.

Feature 2: historical earning feature

In one embodiment, the historical earning feature is generated by the following steps: selecting one search term as the current search term from the search terms input by the respective second users, and selecting one application as the current application from respective applications obtained based on the current search term; counting, according to the historical search record, the number of users who downloaded the current application in all second users who input the current search term, and the number of times the current application is displayed in search lists of all second users who input the current search term; calculating a ratio of the number of users to the number of times as a corresponding historical earning feature; and returning to select another search term as the current search term from the search terms input by the respective second users and select another application as the current application from respective applications obtained based on the current search term until all historical earning features are generated.

Feature 3: title relevance features

In one embodiment, the relevance feature is generated by the following steps: selecting one search term as the current search term from the search terms input by the respective second users, and selecting one application as the current application from respective applications obtained based on the current search term; segmenting the current search term, calculating a word frequency and an inverse document frequency of segments appearing in the current search term, and obtaining a feature vector of the current search term according to the word frequency and the inverse document frequency; segmenting text information of the current application, calculating a word frequency and an inverse document frequency of segments appearing in the text information, and obtaining a feature vector of the text information according to the word frequency and the inverse document frequency, wherein the text information includes title and/or description information; taking a cosine value of an angle between the feature vector of the current search term and the feature vector of the text information as a corresponding relevance feature; and returning to select another search term as the current search term from the search terms input by the respective second users and select another application as the current application from respective applications obtained based on the current search term until all relevance features are generated.

The title relevance feature is calculated by replacing the text information in the above steps with the title.

Feature 4: description relevance feature

In one embodiment, the relevance feature is generated by the following steps: selecting one search term as the current search term from the search terms input by the respective second users, and selecting one application as the current application from respective applications obtained based on the current search term; segmenting the current search term, calculating a word frequency and an inverse document frequency of segments appearing in the current search term, and obtaining a feature vector of the current search term according to the word frequency and the inverse document frequency; segmenting text information of the current application, calculating a word frequency and an inverse document frequency of segments appearing in the text information, and obtaining a feature vector of the text information according to the word frequency and the inverse document frequency, wherein the text information includes title and/or description information; calculating a cosine value of an angle between the feature vector of the current search term and the feature vector of the text information as a corresponding relevance feature; and returning to select another search term as the current search term from the search terms input by the respective second users and select another application as the current application from respective applications obtained based on the current search term until all relevance features are generated.

The paragraph immediately above describes how to calculate a relevance feature. To calculate a description relevance feature, replace the text information in the above steps with the description information.

Feature 5: segment-to-application features

In one embodiment, the segment-to-application feature is generated by the following steps: selecting one search term as the current search term from the search terms input by the respective second users, and selecting one application as the current application from respective applications obtained based on the current search term; segmenting the current search term; combining a segment of the current search term with the title of the current application as a corresponding segment-to-application feature; and returning to select another search term as the current search term from the search terms input by the respective second users and select another application as the current application from respective applications obtained based on the current search term until all segment-to-application features are generated.

Feature 6: relevance-popularity crossing feature

In one embodiment, the relevance-popularity crossing feature is generated by the following steps: ranking the respective applications obtained based on the current search term in descending order according to the relevance feature to obtain a relevance ranking of the current application in all applications; counting, according to the historical search record, the download amount or times of the respective applications obtained based on the current search term in a preset time, ranking the respective applications obtained based on the current search term in descending order according to the download amount/times, and obtaining a popularity ranking of the current application in all applications; crossing the relevance ranking and the popularity ranking to obtain a corresponding feature of relevance and popularity crossing; and returning to select another search term as the current search term from the search terms input by the respective second users and select another application as the current application from respective applications obtained based on the current search term until all relevance-popularity crossing features are generated.

In operation C, the respective second features are input into a preset model for training to generate a prediction model.

After the respective second features are generated, model feature data, that is, training samples, is obtained, as shown in Table 2. Optionally, the preset model is an LR (Logical Regression) model. The data in table 2 (training sample data) is trained using the industry's commonly used LR model training algorithm to obtain model parameters, that is, the preset model.

An application displaying module 140 is configured to rank the respective applications in the candidate application set in descending order according to the estimated click-through rates, and display the applications in the candidate application set to the first user in a sequence ranked in descending order.

The offline trained model estimates a click-through rate for each application in the recalled application candidate set, ranks the applications in descending order according to the estimated click-through rates, and returns the same to the user for displaying in the ranked order, so that the user may quickly select the required application.

In one embodiment, the present disclosure also provides a computer readable storage medium having stored thereon a computer program that, when executed by a processor, implements the application retrieval method of any of the foregoing. The storage medium includes, but is not limited to, any type of disk (including a floppy disk, a hard disk, an optical disk, a CD-ROM, and a magneto-optical disk), a ROM (Read-Only Memory), and a RAM (Random Access Memory), an EPROM (Erasable Programmable Read-Only Memory), an EEPROM (Electrically Erasable Programmable Read-Only Memory), a flash memory, a magnetic card or light card. That is, the storage medium includes any medium that is stored or transmitted by a device (e.g., a computer) in a readable form, which may be a read-only memory, a magnetic disk or an optical disc, and the like.

In an embodiment, the present disclosure further provides a terminal, including: one or more processors; a storage device configured to store one or more programs, wherein the one or more programs are executed by the one or more processors such that the one or more processors implement the application retrieval method of any of the foregoing.

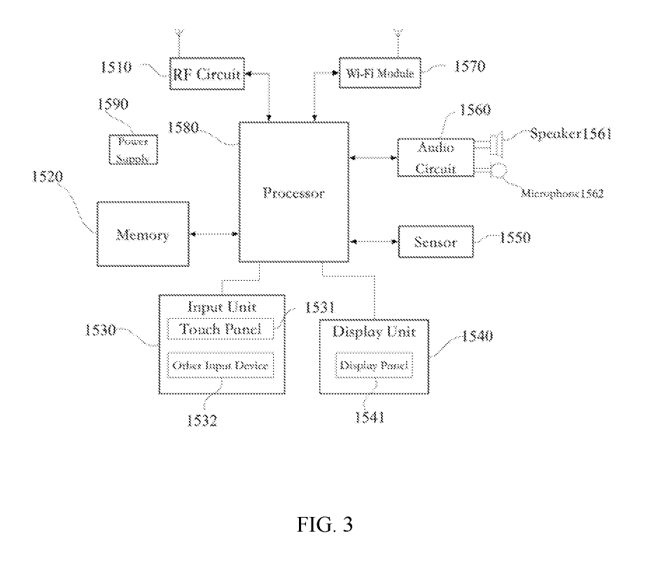

As shown in FIG. 3, for the convenience of description, only the parts related to the embodiments of the present disclosure are shown. For the specific technical details not disclosed, reference can be made to the various methods in the embodiment of the present disclosure. The terminal may be any terminal device including a mobile phone, a tablet computer, a PDA (Personal Digital Assistant), a POS (Point of Sales), an in-vehicle computer. The terminal being a mobile phone is taken as an example,

FIG. 3 is a block diagram showing a partial structure of a mobile phone related to the terminal provided by an embodiment of the present disclosure. In referring to FIG. 3, the mobile phone includes: a radio frequency (RF) circuit 1510, a memory 1520, an input unit 1530, a display unit 1540, a sensor 1550, an audio circuit 1560, a wireless fidelity (Wi-Fi) module 1570, a processor 1580, a power supply 1590 and other components. It will be understood by those skilled in the art that the structure of the mobile phone shown in FIG. 3 does not constitute a limitation to the mobile phone, and may include more or less components than those illustrated, or a combination of some components, or different component arrangements.

The following describes the respective components of the mobile phone in detail with reference to FIG. 3:

The RF circuit 1510 may be used for receiving and transmitting signals during the transmission or reception of information or during a call. Specifically, after receiving downlink information from a base station, the downlink information is processed by the processor 1580. In addition, data designed for the uplink is sent to the base station. Generally, the RF circuit 1510 includes, but is not limited to, an antenna, at least one amplifier, a transceiver, a coupler, a Low Noise Amplifier (LNA), a duplexer, and the like. In addition, the RF circuitry 1510 may also communicate with the network and other devices via wireless communication. The above wireless communication may use any communication standard or protocol, including but not limited to Global System of Mobile communication (GSM), General Packet Radio Service (GPRS), Code Division Multiple Access (CDMA), Wideband Code Division Multiple Access (WCDMA), Long Term Evolution (LTE), E-mail, Short Messaging Service (SMS), and the like.

The memory 1520 may be used to store software programs and modules. The processor 1580 executes various functional applications and data processing of the mobile phone by running the software programs and modules stored in the memory 1520. The memory 1520 may include a program storage area and a data storage area. The program storage area may store an operating system, an application required for at least one function (such as an application retrieval function, etc.), or the like. The data storage area may store data (such as historical search data, etc.) created according to the usage of the mobile phone. Moreover, the memory 1520 may include a high speed random access memory, and may also include a non-volatile memory, such as at least one magnetic disk storage device, flash memory device, or other volatile solid state storage device.

The input unit 1530 may be configured to receive input numeric or character information and to generate key signal inputs related to user settings and function controls of the mobile phone. Specifically, the input unit 1530 may include a touch panel 1531 and other input device 1532. The touch panel 1531, also referred to as a touch screen, may collect touch operations of the user on or near the touch panel (for example, the user uses any proper article or accessory such as a finger, a stylus, or the like to operate on the touch panel 1531 or near the touch panel 1531), and drive a corresponding connecting device according to a preset program. Optionally, the touch panel 1531 may include two parts: a touch detection device and a touch controller. The touch detection device detects the touch orientation of the user, detects a signal generated by the touch operation, and transmits the signal to the touch controller. The touch controller receives the touch information from the touch detection device, converts the touch information into contact coordinates, and sends the same to the processor 1580, and may receive commands from the processor 1580 and execute them. In addition, the touch panel 1531 may be implemented in various types such as resistive, capacitive, infrared, and surface acoustic waves. In addition to the touch panel 1531, the input unit 1530 may also include other input device 1532. Specifically, other input device 1532 may include, but are not limited to, one or more of a physical keyboard, a function key (such as a volume control button, a switch button, etc.), a trackball, a mouse, a joystick, and the like.

The display unit 1540 may be used to display information input by the user or information provided to the user as well as various menus of the mobile phone. The display unit 1540 may include a display panel 1541. Alternatively, the display panel 1541 may be configured in the form of a liquid crystal display (LCD), an organic light-emitting diode (OLED), or the like. Further, the touch panel 1531 may cover the display panel 1541. After the touch panel 1531 detects a touch operation on or near the touch panel, the touch panel 1531 transmits the same to the processor 1580 to determine the type of the touch event. Then the processor 1580, according to the type of the touch event, provides a corresponding visual output on the display panel 1541. Although in FIG. 3, the touch panel 1531 and the display panel 1541 are used as two independent components to implement the input and output functions of the mobile phone, in some embodiments, the touch panel 1531 and the display panel 1541 may be integrated to realize the input and output functions of the mobile phone.

The mobile phone may also include at least one type of sensor 1550, such as a light sensor, a motion sensor, and other sensors. Specifically, the light sensor may include an ambient light sensor and a proximity sensor. The ambient light sensor may adjust the brightness of the display panel 1541 according to the brightness of the ambient light. The proximity sensor may close the display panel 1541 and/or the backlight when the mobile phone moves to the ear. As a kind of motion sensor, an accelerometer sensor may detect the acceleration of each direction (usually three axes), may detect the magnitude and direction of gravity at rest, and may be used for an application that identifies the gesture of the mobile phone (such as horizontal and vertical screen switching, related game, magnetometer attitude calibration) and vibration recognition related functions (such as pedometer, tapping), etc. Other sensors such as gyroscopes, barometers, hygrometers, thermometers, infrared sensors, etc. that may be equipped on mobile phones will not be described here.

An audio circuit 1560, a speaker 1561, and a microphone 1562 may provide an audio interface between the user and the mobile phone. The audio circuit 1560 may transmit the converted electrical data of the received audio data to the speaker 1561, and the speaker 1561 converts it into a voiceprint signal output. On the other hand, the microphone 1562 converts the collected voiceprint signal into an electrical signal which is received by the audio circuit 1560 to be converted to audio data, and the audio data is output to the processor 1580 for processing and transmission to the other mobile device via the RF circuit 1510, or the audio data is output to the memory 1520 for further processing.

Wi-Fi is a short-range wireless transmission technology. The mobile phone may help users to send and receive e-mail, browse web pages and access streaming media through the Wi-Fi module 1570. It provides users with wireless broadband Internet access. Although FIG. 3 shows the Wi-Fi module 1570, it may be understood that it does not belong to the essential configuration of the mobile phone, and may be omitted as needed within the scope of not changing the essence of the present disclosure.

The processor 1580 is the control center for the mobile phone that connects various portions of the entire mobile phone using various interfaces and lines, and execute various functions and processing data of the mobile phone by running or executing the software programs and/or modules stored in the memory 1520 and invoking data stored in the memory 1520, so as to realize overall monitoring of the mobile phone. Optionally, the processor 1580 may include one or more processing units. Preferably, the processor 1580 may integrate an application processor and a modem processor. The application processor mainly processes an operating system, a user interface, an application, and the like. The modem processor primarily handles wireless communications. It will be appreciated that the above described modem processor may also not be integrated into the processor 1580.

The mobile phone also includes a power supply 1590 (such as a battery) that supplies power to the various components. Preferably, the power supply may be logically connected to the processor 1580 via a power management system to manage functions such as charging, discharging, and power consumption management through the power management system.

Although not shown, the mobile phone may further include a camera, a Bluetooth module, and the like, and details are not described herein again.

The above application retrieval method and device, storage medium and terminal start from the three aspects of content matching degree, application quality and user feedback, and establish a prediction model for fine arrangement. The effect of the click-through rate, conversion rate and the like is greatly improved compared to the traditional tf-idf algorithm to better meet the user's retrieval needs.

It should be understood that although the various steps in the flowchart of the drawings are sequentially displayed as indicated by the arrows, these steps are not necessarily performed in the order indicated by the arrows. Except as explicitly stated herein, the execution of these steps is not strictly limited, and may be performed in other sequences. Moreover, at least some of the steps in the flowchart of the drawings may include a plurality of sub-steps or stages, which are not necessarily performed at the same time, but may be executed at different time. The execution order thereof is also not necessarily performed sequentially, but may be performed alternately or alternately with at least a portion of other steps or sub-steps or stages of other steps.

The above description is only some embodiments of the present disclosure, and it should be noted that those skilled in the art may also make several improvements and modifications without departing from the principles of the present disclosure which should be considered as the scope of protection of the present disclosure.

What is claimed is:

1. An application retrieval method, comprising the steps of:
obtaining a candidate application set according to a search term input by a first user;
generating respective first features for characterizing relationships between the search term input by the first user and respective applications in the candidate application set;
inputting the respective first features into a prediction model to obtain estimated click-through rates of the respective applications in the candidate application set, wherein the prediction model is used to represent association relationships between features and estimated click-through rates of applications; and
ranking the respective applications in the candidate application set in descending order according to the estimated click-through rates, and displaying the respective applications in the candidate application set to the first user in a sequence ranked in descending order.

2. The application retrieval method according to claim 1, wherein before obtaining estimated click-through rates of the respective applications in the candidate application set, the method further comprises:
acquiring historical search records of respective second users, wherein each of the historical search records includes an input search term, respective applications obtained based on the search term, and information about whether the respective applications obtained based on the search term are downloaded;
generating respective second features for characterizing relationships between the search terms input by the respective second users and the respective applications obtained based on each of the search terms; and
inputting the respective second features into a preset model for training to generate the prediction model.

3. The application retrieval method according to claim 2, wherein the second features comprise a relevance feature, said relevance feature generated by the following steps:
selecting one search term as the current search term from the search terms input by the respective second users, and selecting one application as the current application from respective applications obtained based on the current search term;
segmenting the current search term, calculating a word frequency and an inverse document frequency of segments appearing in the current search term, and obtaining a feature vector of the current search term according to the word frequency and the inverse document frequency;
segmenting text information of the current application, calculating a word frequency and an inverse document frequency of segments appearing in the text information, and obtaining a feature vector of the text information according to the word frequency and the inverse document frequency, wherein the text information includes title and/or description information;
calculating the cosine value of an angle between the feature vector of the current search term and the feature vector of the text information as a corresponding relevance feature; and
returning to select another search term as the current search term selected from the search terms input by the respective second users and another application as the current application selected from respective applications obtained based on the current search term until all relevance features are generated.

4. The application retrieval method according to claim 3, wherein each of the historical search records further includes the time when the respective applications are downloaded; and the second feature further includes a relevance-popularity crossing feature, the relevancy-popularity crossing feature being generated by the following steps:
ranking the respective applications obtained based on the current search term in descending order according to the relevance feature to obtain a relevance ranking of the current application in all applications;
counting, according to the historical search records, download times of the respective applications obtained based on the current search term in a preset time period, ranking the respective applications obtained based on the current search term in descending order according to the download times, and obtaining a popularity ranking of the current application in all applications;
crossing the relevance ranking and the popularity ranking to obtain a corresponding relevance-popularity crossing feature; and
returning to select another search term as the current search term from the search terms input by the respective second users and another application as the current application from respective applications obtained based on the current search term until all relevance-popularity crossing features are generated.

5. The application retrieval method according to claim 2, wherein the second features further comprise a historical earning feature, which is generated by the following steps:
selecting one search term as the current search term from the search terms input by the respective second users, and selecting one application as the current application from respective applications obtained based on the current search term;
counting, according to the historical search records, the number of users who have downloaded the current application among all second users who input the current search term, and the number of times the current application is displayed in search lists of all second users who input the current search term;
calculating a ratio of the number of users to the number of download times as a corresponding historical earning feature; and
returning to select another search term as the current search term selected from the search terms input by the respective second users and another application as the current application selected from respective applications obtained based on the current search term until all historical earning features are generated.

6. The application retrieval method according to claim 5, wherein the second features further comprise an exact matching feature, which is generated by the following steps:
selecting a search term as the current search term from the search terms input by the respective second users, and selecting an application as the current application from respective applications obtained based on the current search term;
determining whether a title of the current application matches the current search term;
if yes, assigning a first value to a corresponding exact matching feature; otherwise, assigning a second value to a corresponding exact matching feature; and
returning to select another search term as the current search term selected from the search terms input by the respective second users and another application as the current application selected from respective applications obtained based on the current search term until all exact matching features are generated.

7. The application retrieval method according to claim 5, wherein the second features further comprise a segment-to-application feature, which is generated by the following steps:
selecting one search term as the current search term from the search terms input by the respective second users, and selecting one application as the current application from respective applications obtained based on the current search term;
segmenting the current search term;
combining a segment of the current search term with the title of the current application as a corresponding segment-to-application feature; and
returning to select another search term as the current search term selected from the search terms input by the respective second users and another application as the current application selected from respective applications obtained based on the current search term until all segment-to-application features are generated.

8. The application retrieval method according to claim 1, wherein the first feature is one-hot encoded.

9. An application retrieval device, comprising:
a candidate application set obtaining circuit configured to obtain a candidate application set according to a search term input by a first user;
a first feature generating circuit configured to generate respective first features for characterizing relationships between the search term input by the first user and respective applications in the candidate application set;
an estimated click-through rate obtaining circuit configured to input the respective first features into a prediction model to obtain estimated click-through rates of the respective applications in the candidate application set, wherein the prediction model is used to represent association relationships between features and estimated click-through rates of applications; and
an application displaying circuit configured to rank the respective applications in the candidate application set in descending order according to the estimated click-through rates, and display the respective applications in the candidate application set to the first user in a sequence ranked in descending order.

10. A computer readable storage medium having stored thereon a computer program, wherein the program is executed by a processor to implement the application retrieval method of claim 1.

11. A terminal, comprising:
one or more processors; and
a storage device configured to store one or more programs;
wherein the one or more programs are executed by the one or more processors to perform the application retrieval method of claim 1.
